(19) United States
(12) Patent Application Publication
(10) Pub. No.: US 2021/0309244 A1
(43) Pub. Date: Oct. 7, 2021

(54) APPARATUS AND METHOD FOR WARNING ABOUT DRIVING OF VEHICLE

(71) Applicants: Hyundai Motor Company, Seoul (KR); Kia Motors Corporation, Seoul (KR)

(72) Inventors: Beom Jun Kim, Seoul (KR); Dae Young Kim, Gwangmyeong (KR)

(21) Appl. No.: 17/036,195

(22) Filed: Sep. 29, 2020

(30) Foreign Application Priority Data
Apr. 3, 2020 (KR) 10-2020-0041120

(51) Int. Cl. B60W 50/14; B60W 40/09; B60W 40/105; B60W 30/12; B60W 50/02

(52) U.S. Cl. CPC B60W 50/14; B60W 40/09; B60W 40/105; B60W 30/12; B60W 2520/00; B60W 2540/30; B60W 2540/223; B60W 2050/146; B60W 50/02

(57) ABSTRACT

An apparatus for providing a warning about the driving of a vehicle is provided and includes a sensor that obtains a state of a driver and a state of the vehicle. An input device receives, from the driver, risk criteria information including critical speed and holding time of a driving assistance function that are defined based on a tendency of the driver. A storage stores at least one program instruction executed by a controller. The controller sets at least one additional warning output condition based on the risk criteria information, determines whether the additional warning output condition is satisfied, based on the state of the driver and the state of the vehicle, and outputs a driving warning based on an outcome of the determination.

### CROSS-REFERENCE TO RELATED APPLICATION

This application claims the benefit of priority to Korean Patent Application No. 10-2020-0041120, filed on Apr. 3, 2020, the entire contents of which are incorporated herein by reference.

### TECHNICAL FIELD

The present disclosure relates to an apparatus and method for providing a warning regarding the driving of a vehicle.

### BACKGROUND

Recently, an intelligent driver assistance system has been developed to improve driver convenience. The intelligent driver assistance system may perform a driving assistance function of helping a driver of a vehicle to drive while maintaining a lane or speed in consideration of a road ahead the vehicle and an obstacle around the vehicle.

Meanwhile, when the driving assistance function is unable to be performed, the intelligent driver support system may warn the driver that the driving assistance function is deactivated. However, since the warning based on the deactivation of the driving assistance function is collectively performed, the driver may fail to recognize the warning and may determine that usability is lowered. Alternatively, the driver may feel danger for lack of warning. Accordingly, a technology for outputting a warning based on a tendency of a driver even when a driving assistance function is deactivated is required.

### SUMMARY

The present disclosure has been made to solve the above-mentioned problems occurring in the prior art while advantages achieved by the prior art are maintained intact. An aspect of the present disclosure provides a vehicle driving warning apparatus and method for outputting a warning based on a tendency of a driver when a driving assistance function is deactivated. The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for warning about driving of a vehicle may include a sensor configured to obtain a state of a driver and a state of the vehicle, an input device configured to receive, from the driver, risk criteria information including critical speed and holding time of a driving assistance function that are defined based on a tendency of the driver, and a controller configured to set at least one additional warning output condition based on the risk criteria information, determine whether the additional warning output condition is satisfied, based on the state of the driver and the state of the vehicle, and output a driving warning based on an outcome of the determination.

The controller may be configured to receive the risk criteria information input from the driver, when the controller determines that the driving assistance function is deactivated, based on the state of the vehicle obtained from the sensor. The controller may be configured to adjust additional warning output time based on the critical speed and the holding time. Additionally, the controller may be configured to set, as the additional warning output condition, a case in which the driver is in a hand-off state, a warning depending on the hand-off state is not output, speed of the vehicle exceeds the critical speed, and the holding time of the driving assistance function exceeds holding time input from the driver.

The sensor may be configured to obtain the state of the driver by sensing the hand-off state in which the driver does not grasp a steering wheel. The sensor may be configured to obtain the state of the vehicle by sensing the speed of the vehicle. The controller may be configured to output the additional warning through an output device at output time adjusted based on the critical speed and the holding time, when a condition for outputting the additional warning is satisfied based on the state of the driver and the state of the vehicle.

Further, the controller may be configured to output a warning based on deactivation of the driving assistance function through the output device, when the condition for outputting the additional warning is not satisfied based on the state of the driver and the state of the vehicle. The output device may be configured to output the warning based on the deactivation of the driving assistance function through an image representing the warning and output the additional warning through a visual pop-up function and an auditory function. The driving assistance function may include a lane keeping function.

According to another aspect of the present disclosure, a method for warning about driving of a vehicle may include obtaining a state of a driver and a state of the vehicle, receiving, from the driver, risk criteria information including critical speed and holding time of a driving assistance function that are defined based on a tendency of the driver, setting at least one additional warning output condition based on the risk criteria information, determining whether the additional warning output condition is satisfied, based on the state of the driver and the state of the vehicle, and outputting a driving warning based on an outcome of the determination.

The risk criteria information input from the driver may be received in response to determining that the driving assistance function is deactivated, based on the state of the vehicle. Additional warning output time may be adjusted based on the critical speed and the holding time. A case in which the driver is in a hand-off state, a warning based on the hand-off state is not output, speed of the vehicle exceeds the critical speed, and the holding time of the driving assistance function exceeds holding time input by the driver may be set as the additional warning output condition.

The state of the driver may be obtained by detecting the hand-off state in which the driver does not grasp a steering wheel. The state of the vehicle may be obtained by detecting the speed of the vehicle. Control may be performed to output the additional warning at output time adjusted based on the critical speed and the holding time, when a condition for outputting the additional warning is satisfied based on the state of the driver and the state of the vehicle.

Additionally, control may be performed to output a warning based on deactivation of the driving assistance function, when the condition for outputting the additional warning is not satisfied based on the state of the driver and the state of the vehicle. The warning based on the deactivation of the driving assistance function may be output through an image representing the warning, and the additional warning may be output through a visual pop-up function and an auditory function. The driving assistance function may include a lane keeping function.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a configuration of an apparatus for warning about driving of a vehicle according to an exemplary embodiment of the present disclosure;

FIG. 2 is a flowchart illustrating a method for warning about driving of a vehicle according to an exemplary embodiment of the present disclosure;

FIG. 3 is a flowchart illustrating a method for determining whether an additional warning output condition is satisfied, according to an exemplary embodiment of the present disclosure; and

FIG. 4 is a view illustrating a configuration of a computing system for executing a method according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application

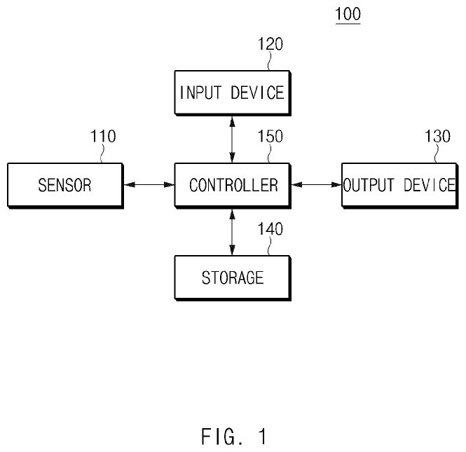

FIG. 1 is a view illustrating a configuration of an apparatus for warning about driving of a vehicle according to an exemplary embodiment of the present disclosure. As illustrated in FIG. 1, the apparatus 100 for warning about the driving of the vehicle according to the exemplary embodiment of the present disclosure may include a sensor 110, an input device 120, an output device 130, storage 140, and a controller 150.

The sensor 110 may include various types of sensors within the vehicle. According to an exemplary embodiment, the sensor 110 may be configured to obtain a state of a driver and a driving state of the vehicle and transmit the obtained information to the controller 150 via an in-vehicle network. According to an exemplary embodiment, the sensor 110 may be configured to obtain the driver's state by sensing whether the driver grasps the steering wheel. Furthermore, the sensor 110 may be configured to obtain the vehicle's driving state by sensing the driving speed of the vehicle. In addition, the sensor 110 may be configured to obtain the vehicle's driving state by sensing whether a driving assistance function is activated, based on a control signal output when the driving assistance function is activated.

The input device 120 may be configured to receive risk criteria information from the driver, or output a signal based on manipulation of the driver. Accordingly, the input device 120 may be implemented with at least one of a scroll wheel, a button, a knob, a touch screen, a touch pad, a lever, or a gesture sensor, or a combination thereof. In particular, the risk criteria information may include critical speed corresponding to a dangerous environment defined by the driver and driving assistance function holding time (e.g., keeping time) corresponding to the dangerous environment defined by the driver. In addition, the driving assistance function holding time may refer to time during which the driving assistance function is maintained until the driving assistance function is deactivated.

The output device 130 may be configured to output a driving warning based on an outcome of determination by the controller 150. According to an exemplary embodiment, the output device 130 may be configured to visually or acoustically output the driving warning. In particular, the output device 130 may be configured to output a warning based on deactivation of the driving assistance function through an image that represents the warning and may be configured to output an additional warning through a visual pop-up function and an auditory function. Accordingly, the output device 130 may be implemented with a display device or a sound output device.

For operation of the apparatus 100 for warning regarding the driving of the vehicle according to the exemplary embodiment of the present disclosure, the storage 140 may be configured to store at least one algorithm for performing operation or execution of various commands. The storage 140 may include at least one of a flash memory, a hard disc, a memory card, a Read-Only Memory (ROM), a Random Access Memory (RAM), an Electrically Erasable Programmable Read-Only Memory (EEPROM), a Programmable Read-Only Memory (PROM), a magnetic memory, a magnetic disc, or an optical disc.

The controller 150 may be implemented by various processing devices such as a microprocessor having a semiconductor chip capable of performing operation or execution of various commands and may be configured to execute an overall operation of the apparatus 100 for providing a warning regarding the driving of the vehicle according to the exemplary embodiment of the present disclosure, based on the at least one algorithm stored in the storage 140. Specifically, according to an exemplary embodiment of the present disclosure, the controller 150 may be configured to set at least one additional warning output condition based on the risk criteria information, determine whether the additional warning output condition is satisfied, based on the driver's state and the vehicle's driving state, and output the driving warning based on an outcome of the determination.

More specifically, after the ignition of the vehicle is turned on, the controller 150 may be configured to detect whether the driving assistance function is activated, based on the driving state obtained from the sensor 110, and in response to determining that the driving assistance function is deactivated, the controller 150 may be configured to receive the risk criteria information input by the driver. Particularly, the driving assistance function may be provided by an Advanced Driving Assistance System (ADAS) and may include, for example, a function of adjusting an inter-vehicle distance by adjusting longitudinal speed while maintaining a lane by detecting a forward vehicle and the lane and a lane keeping function of warning the driver about lane departure, or returning the vehicle to the lane, when the vehicle departs the lane.

Furthermore, the risk criteria information input by the driver may be input through the input device 120 and may be input differently based on a tendency of the driver. According to an exemplary embodiment, the tendency of the driver may include a tendency to want an additional warning output to frequently detect dangerous situations and a tendency to want an additional warning output to infrequently detect dangerous situations. In particular, the risk criteria information may include the critical speed that corresponds to the dangerous environment defined by the driver and the driving assistance function holding time that corresponds to the dangerous environment defined by the driver. In addition, the driving assistance function holding time may refer to the time during which the driving assistance function is maintained until the driving assistance function is deactivated.

For example, when the driver has the tendency to want the warning output to frequently detect the dangerous situations, the critical speed that corresponds to the dangerous environment defined by the driver may be set to about 5 kph, and the driving assistance function holding time may be set to about 1 second. In another example, when the driver has the tendency to want the warning output to infrequently detect the dangerous situations, the critical speed that corresponds to the dangerous environment defined by the driver may be set to about 20 kph, and the driving assistance function holding time may be set to about 4 seconds.

The controller 150 may be configured to set at least one additional warning output condition based on the tendency of the driver using the risk criteria information input by the driver. According to an exemplary embodiment, the controller 150 may be configured to set, as the additional warning output condition, a case where a hand-off state is determined based on the driver's state and the vehicle's state, a warning based on the hand-off state is not output, the speed of the vehicle exceeds the critical speed that corresponds to the dangerous environment defined by the driver, and holding time of the driving assistance function exceeds the driving assistance function holding time input by the driver.

After it is determined that the driving assistance function is deactivated, the controller 150 may be configured to output an additional warning when the driver's state and the vehicle's driving state satisfy the additional warning output condition set based on the tendency of the driver. Accordingly, the controller 150 may be configured to adjust additional warning output time based on the critical speed and the holding time input by the driver and allow the additional warning to be output based on the tendency of the driver.

For example, when the driver having the tendency to want the warning output to frequently detect the dangerous situations inputs risk criteria information (e.g., critical speed of about 5 kph and holding time of about 1 second), the controller 150 may be configured to determine that the driver's state and the vehicle's driving state satisfy the additional warning output condition, when the controller 150 determines that the driver is in a hand-off state of not grasping the steering wheel, based on the driver's state, the controller 150 may be configured to determine that a warning related to not grasping the steering wheel (e.g., a warning depending on the hand-off state) is not output, and the controller 150 may be configured to determine that the vehicle speed is 10 kph and the driving assistance function is maintained for 3 seconds, based on the vehicle's driving state. In response to determining that the additional warning output condition is satisfied, the controller 150 may be configured to output a warning based on deactivation of the driving assistance function and an additional warning. According to an exemplary embodiment, the additional warning may be output through a visual pop-up function or an auditory function.

Meanwhile, when the driver having the tendency to want the warning output to frequently detect the dangerous situations inputs risk criteria information (e.g., critical speed of about 5 kph and holding time of about 1 second), when the controller 150 determines that the driver grasps the steering wheel (e.g., is not in a hand-off state), based on the driver's state, when the controller 150 determines that a warning relating to not grasping the steering wheel (e.g., a warning depending on the hand-off state) is output, or when the controller 150 determines that the vehicle speed is about 5 kph or less or the driving assistance function is maintained for about 1 second or less, based on the vehicle's driving state, the controller 150 may be configured to determine that the driver's state and the vehicle's driving state do not satisfy the additional warning output condition. Accordingly, the controller 150 may be configured to output only the warning based on the deactivation of the driving assistance function without outputting the additional warning. According to an exemplary embodiment, when outputting only the warning about the deactivation of the driving assistance function, the controller 150 may be configured to output a driving warning by using a method of outputting an image (e.g., a symbol) that represents the warning.

In another example, when the driver having the tendency to want the warning output to infrequently detect the dangerous situations inputs risk criteria information (e.g., critical speed of about 20 kph and holding time of about 4 seconds), the controller 150 may be configured to determine that the driver's state and the vehicle's driving state satisfy the additional warning output condition, when the controller 150 determines that the driver does not grasp the steering wheel (e.g., is in a hand-off state), based on the driver's state, the controller 150 may be configured to determine that a warning relating to not grasping the steering wheel (e.g., a warning depending on the hand-off state) is not output, and the controller 150 may be configured to determine that the vehicle speed is 30 kph and the driving assistance function is maintained for 5 seconds, based on the vehicle's driving state. In response to determining that the additional warning output condition is satisfied, the controller 150 may be configured to output a warning based on deactivation of the driving assistance function and an additional warning. According to an exemplary embodiment, the additional warning may be output through a visual pop-up function or an auditory function.

Meanwhile, when the driver having the tendency to want the warning output to infrequently detect the dangerous situations inputs risk criteria information (e.g., critical speed of about 20 kph and holding time of about 4 seconds), when the controller 150 determines that the driver grasps the steering wheel (e.g., is not in a hand-off state), based on the driver's state, when the controller 150 determines that a warning relating to not grasping the steering wheel (e.g., a warning depending on the hand-off state) is output, or when the controller 150 determines that the vehicle speed is 20 kph or less or the driving assistance function is maintained for 4 seconds or less, based on the vehicle's driving state, the controller 150 may be configured to determine that the driver's state and the vehicle's driving state do not satisfy the additional warning output condition. Accordingly, the controller 150 may be configured to output only a warning based on deactivation of the driving assistance function without outputting an additional warning. According to an exemplary embodiment, when outputting only the warning about the deactivation of the driving assistance function, the controller 150 may be configured to output a driving warning by using a method of outputting an image (e.g., a symbol) that represents the warning.

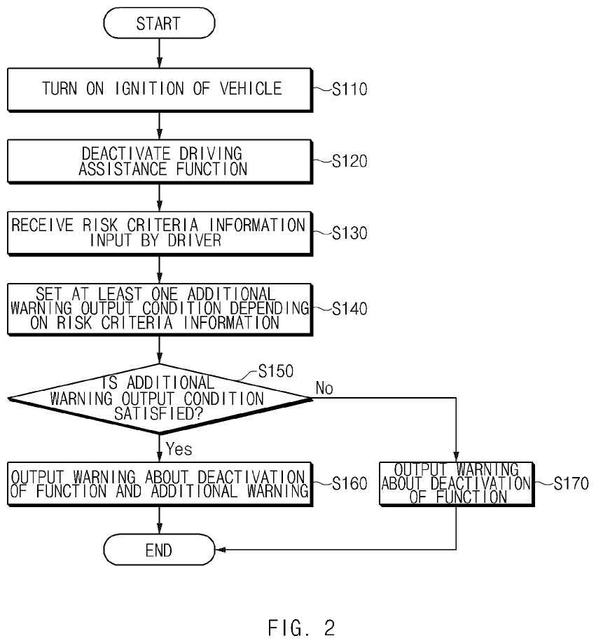

FIG. 2 is a flowchart illustrating a method for providing a warning regarding the driving of a vehicle according to an exemplary embodiment of the present disclosure. As illustrated in FIG. 2, according to the present disclosure, in response to determining that the ignition of the vehicle is turned on (S110), the controller 150 may be configured to determine whether a driving assistance function is deactivated (S120). In response to determining that the driving assistance function is deactivated, the controller 150 may be configured to receive risk criteria information input by a driver (S130). The risk criteria information in S130 may include information that is input differently based on a tendency of the driver.

According to an exemplary embodiment, the tendency of the driver may include a tendency to want an additional warning output to frequently detect dangerous situations and a tendency to want an additional warning output to infrequently detect dangerous situations. The risk criteria information may include critical speed that corresponds to a dangerous environment defined by the driver and driving assistance function holding time that corresponds to the dangerous environment defined by the driver. The driving assistance function holding time may refer to time during which the driving assistance function is maintained until the driving assistance function is deactivated.

In S130, the controller 150 may be configured to receive risk criteria information set by the driver having the tendency to want the warning output to frequently detect the dangerous situation, or may receive risk criteria information set by the driver having the tendency to want the warning output to infrequently detect the dangerous situation. The controller 150 may be configured to set at least one additional warning output condition based on the tendency of the driver, based on the risk criteria information in S130 (S140). In S140, according to an exemplary embodiment, the controller 150 may be configured to set, as the additional warning output condition, a case where a hand-off state is determined based on the driver's state and the vehicle's state, a warning based on the hand-off state is not output, the speed of the vehicle exceeds the critical speed that corresponds to the dangerous environment defined by the driver, and holding time of the driving assistance function exceeds the driving assistance function holding time that is input by the driver.

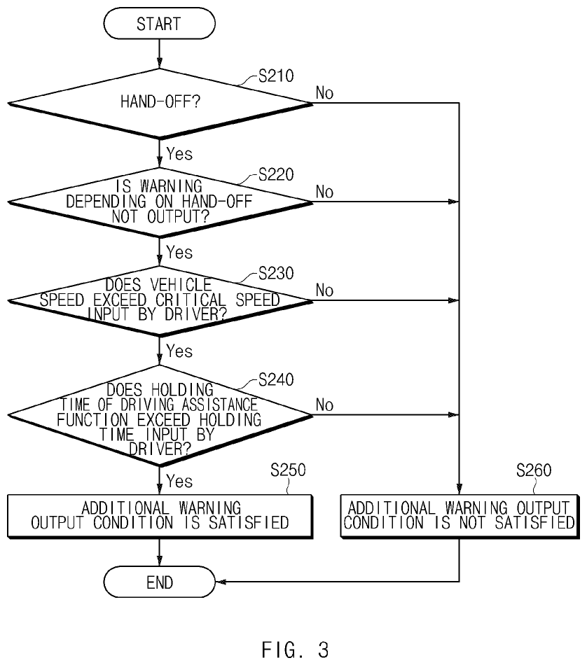

The controller 150 may be configured to determine whether the driver's state and the vehicle's driving state satisfy the additional warning output condition set based on the tendency of the driver (S150). A specific operation of S150 will be described below with reference to FIG. 3. In response to determining in S150 that the driver's state and the vehicle's driving state satisfy the additional warning output condition set based on the tendency of the driver (Y), the controller 150 may be configured to determine that a condition for output of an additional warning is satisfied and output a warning based on the deactivation of the driving assistance function and the additional warning (S160). In S160, according to an exemplary embodiment, the additional warning may be output through a visual pop-up function and an auditory function.

Meanwhile, in response to determining in S150 that the driver's state and the vehicle's driving state do not satisfy the condition set depending on the tendency of the driver (N), the controller 150 may be configured to output only the warning about the deactivation of the driving assistance function without outputting the additional warning (S170). In S170, according to an exemplary embodiment, when outputting only the warning about the deactivation of the driving assistance function, the controller 150 may be configured to output a driving warning using a method of outputting an image (e.g., a symbol) that represents the warning.

FIG. 3 is a flowchart illustrating a method for determining whether the additional warning output condition is satisfied, according to an exemplary embodiment of the present disclosure. As illustrated in FIG. 3, based on the driver's state, the controller 150 may be configured to determine whether the driver is in a hand-off state of not grasping the steering wheel (S210). In response to determining in S210 that the driver is in the hand-off state of not grasping the steering wheel, the controller 150 may be configured to determine whether a warning relating to not grasping the steering wheel (e.g., a warning based on the hand-off state) is not output (S220). In response to determining in S220 that the warning based on the hand-off state is not output (Y), the controller 150 may be configured to determine whether the speed of the vehicle exceeds the critical speed input by the driver (S230).

In response to determining in S230 based on the vehicle's driving state that the speed of the vehicle exceeds the critical speed input by the driver (Y), the controller 150 may be configured to determine whether holding time of the driving assistance function exceeds the driving assistance function holding time input by the driver (S240). In response to determining in S240 that the holding time of the driving assistance function exceeds the driving assistance function holding time input by the driver (Y), the controller 150 may be configured to determine that the driver's state and the vehicle's driving state satisfy the additional warning output condition (S250). In S250, the controller 150 may be configured to output a warning depending on the deactivation of the driving assistance function and an additional warning.

Meanwhile, when the controller 150 determines that the driver is not in the hand-off state of not grasping the steering wheel, based on the driver's state (S210-N), when the controller 150 determines that the warning relating to not grasping the steering wheel (e.g., the warning depending on the hand-off state) is output (S220-Y), when the controller 150 determines that the speed of the vehicle is less than or equal to the critical speed input by the driver, based on the vehicle's driving state (S230-N), or when the controller 150 determines that the holding time of the driving assistance function is less than or equal to the driving assistance function holding time input by the driver (S240-N), the controller 150 may be configured to determine that the driver's state and the vehicle's driving state do not satisfy the additional warning output condition (S260). In S260, the controller 150 may be configured to output only the warning about the deactivation of the driving assistance function without outputting the additional warning.

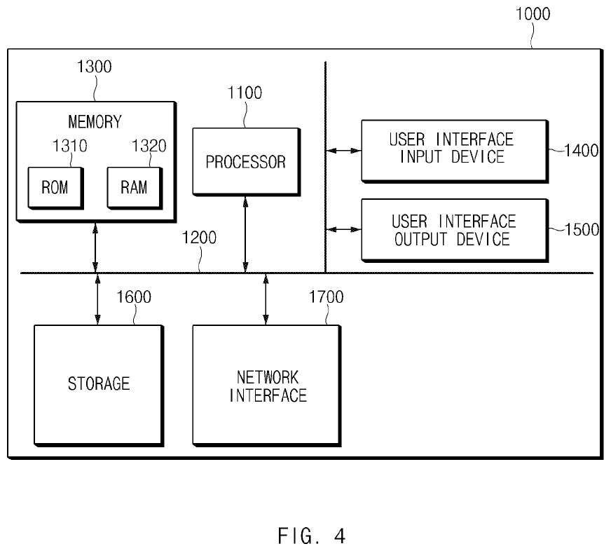

FIG. 4 is a view illustrating a configuration of a computing system for executing a method according to an exemplary embodiment of the present disclosure. Referring to FIG. 4, the computing system 1000 may include at least one processor 1100, a memory 1300, a user interface input device 1400, a user interface output device 1500, storage 1600, and a network interface 1700, which are connected with each other via a bus 1200.

The processor 1100 may be a Central Processing Unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

As described above, according to the exemplary embodiments of the present disclosure, the apparatus and method for warning about the driving of the vehicle outputs a warning based on a tendency of a driver when a driving assistance function is deactivated, thereby improving driver convenience. Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the exemplary embodiments. The scope of the present disclosure should be construed on the basis of the accompanying claims, and all the technical ideas within the scope equivalent to the claims should be included in the scope of the present disclosure.

What is claimed is:

1. An apparatus for warning about driving of a vehicle, comprising:
a sensor configured to obtain a state of a driver and a state of the vehicle;
an input device configured to receive, from the driver, risk criteria information including critical speed and holding time of a driving assistance function that are defined based on a tendency of the driver;
a storage configured to store at least one program instruction executed by a controller, when executed by the processor causes the apparatus to;
set at least one additional warning output condition based on the risk criteria information,
determine whether the additional warning output condition is satisfied, based on the state of the driver and the state of the vehicle, and
output a driving warning based on an outcome of the determination.

2. The apparatus of claim 1, wherein the controller is configured to receive the risk criteria information input from the driver, in response to determining that the driving assistance function is deactivated, based on the state of the vehicle obtained from the sensor.

3. The apparatus of claim 1, wherein the controller is configured to adjust additional warning output time based on the critical speed and the holding time.

4. The apparatus of claim 1, wherein the controller is configured to set, as the additional warning output condition, a case in which the driver is in a hand-off state, a warning based on the hand-off state is not output, speed of the vehicle exceeds the critical speed, and the holding time of the driving assistance function exceeds holding time input from the driver.

5. The apparatus of claim 4, wherein the sensor is configured to obtain the state of the driver by sensing the hand-off state in which the driver does not grasp a steering wheel.

6. The apparatus of claim 5, wherein the sensor is configured to obtain the state of the vehicle by sensing the speed of the vehicle.

7. The apparatus of claim 6, wherein the controller is configured to output the additional warning through an output device at output time adjusted based on the critical speed and the holding time, in response to determining that a condition for outputting the additional warning is satisfied based on the state of the driver and the state of the vehicle.

8. The apparatus of claim 7, wherein the controller is configured to output a warning based on deactivation of the driving assistance function through the output device, in response to determining that the condition for outputting the additional warning is not satisfied based on the state of the driver and the state of the vehicle.

9. The apparatus of claim 8, wherein the output device is configured to output the warning based on the deactivation of the driving assistance function through an image representing the warning and output the additional warning through a visual pop-up function and an auditory function.

10. The apparatus of claim 1, wherein the driving assistance function includes a lane keeping function.

11. A method for warning about driving of a vehicle, comprising:
obtaining, by a controller, a state of a driver and a state of the vehicle;
receiving, from the driver, risk criteria information including critical speed and holding time of a driving assistance function that are defined based on a tendency of the driver;
setting, by the controller, at least one additional warning output condition based on the risk criteria information;
determining, by the controller, whether the additional warning output condition is satisfied, based on the state of the driver and the state of the vehicle; and
outputting, by the controller, a driving warning based on an outcome of the determination.

12. The method of claim 11, wherein the risk criteria information input from the driver is received in response to determining that the driving assistance function is deactivated, based on the state of the vehicle.

13. The method of claim 11, wherein additional warning output time is adjusted based on the critical speed and the holding time.

14. The method of claim 11, wherein a case in which the driver is in a hand-off state, a warning based on the hand-off state is not output, speed of the vehicle exceeds the critical speed, and the holding time of the driving assistance function exceeds holding time input by the driver is set as the additional warning output condition.

15. The method of claim 14, wherein the state of the driver is obtained by detecting the hand-off state in which the driver does not grasp a steering wheel.

16. The method of claim 15, wherein the state of the vehicle is obtained by detecting the speed of the vehicle.

17. The method of claim 16, wherein control is performed to output the additional warning at output time adjusted based on the critical speed and the holding time, in response to determining that a condition for outputting the additional warning is satisfied based on the state of the driver and the state of the vehicle.

18. The method of claim 17, wherein control is performed to output a warning based on deactivation of the driving assistance function, in response to determining the condition for outputting the additional warning is not satisfied based on the state of the driver and the state of the vehicle.

19. The method of claim 18, wherein the warning based on the deactivation of the driving assistance function is output through an image representing the warning, and the additional warning is output through a visual pop-up function and an auditory function.

20. The method of claim 11, wherein the driving assistance function includes a lane keeping function.
